(19) United States
(12) Patent Application Publication
(10) Pub. No.: US 2009/0179006 A1
(43) Pub. Date: Jul. 16, 2009

(54) Method and Device for a Forced Wet-Chemical Treatment of Surfaces

(75) Inventor: Marcus Lang, Schechingen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: LP VERMARKTUNGS GMBH & CO KG, 73579 SCHECHINGEN (DE)

(21) Appl. No.: 12/374,889

(22) PCT Filed: Jul. 21, 2007
(86) PCT No.: PCT/DE2007/001306

§ 371 Date: Jan. 23, 2009

(30) Foreign Application Priority Data
Jul. 25, 2006 (DE) 10 2006 035 523.7
Dec. 14, 2006 (DE) 10 2006 059 046.5

(51) Int. Cl. B44C 1/22; C23F 1/08

(52) U.S. Cl. 216/83; 216/13; 156/345.21

(57) ABSTRACT

In a method for wet-chemical treatment of surfaces of a material. a pulse-like spray jet of treatment fluid is directed against the surface of the material. This causes a pronounced impact action against the base of a structure to be processed so that the amount of treatment time which is necessary is substantially reduced. The pressure-free and accelerated outflow of the treatment fluid from the structure channels in the pauses between pulses results in the flanks of the structures or circuit-board conductors being subjected to less wet-chemical processing than in the prior art. In case of chemical etching the result is a smaller undercutting.

The invention relates to a wet-chemical treatment of a surface of material by means of sprayed or sprinkled treatment fluid. Plants for a wet-chemical treatment may be immersion plants or continuous processing plants. The treatment fluid flows against the surface of a material to be treated from stationary, actuated or oscillating nozzles or nozzle pipes. There is an intention that a sufficient result of the wet-chemical treatment is achieved as quickly as possible. In practice of surface treatment, such an intention is an antagonism since with increasing intensity of surface treatment, i.e. shorter treatment time, achievable results change for the worse. Typical example for application for the treatment of surfaces is printed circuit technology. There are various processes in this technology where the inventive method and device may be applied favorably. This is for example washing or swilling, developing of a film or a resist, etching of copper, stripping of a film or a resist and metal resist etching. Such methods are usually carried out by means of spraying or sprinkling against a material to be processed. On the surface of the material, the necessary mass transfer occurs in corresponding diffusion layer. Such a mass transfer may be accelerated by means of increased spraying pressure, which results in a reduced amount of treatment time. However, in such a case unwanted side effects emerge which unfavorably influence the precision of the treatment result. An example is etching of general structures on the surface of a material or etching of a conductive pattern of printed circuit boards. Areas not to be etched are covered by means of a film or resist. The resist is stable against etching fluid. If an etching by means of spraying or sprinkling of nozzles or nozzle pipes is performed such a treatment does not only occur in exposed areas of etching channels between resist covered areas but in flanks of etchings channels, too. The result is undercutting of the resist that can only be tolerated on a very small scale. Thus, with respect to dimensions and cross-sections of conductor tracks, the result of remaining structures is unpredictable. Especially in precision conductor technology (conductor track widths and spacings of approximately 120 μm and less), a higher and reproducible precision of treatment results is required. Therefore, an unpredictable treatment of flanks of structures by means of other methods mentioned above is also not allowed. In general, in order to achieve the necessary precision of etched structures the treatment time is reduced, which, however, is not appreciated.

In DE 195 24 523 A1 a method and a device is described in order to solve such a problem as mentioned above occurring during wet-chemical treatment of surfaces. A fluid jet combined with cavitation bubbles is created at high pressure in specific nozzles. The fluid jet transports the necessary fresh mass to the diffusion layer on the surface of the material. There, the cavitation bubbles implode resulting in a mass transfer. This method is suitable for the above-mentioned applications and especially for the printed circuit technology. However, the technical complexity of the high pressure units is very high.

In DE 31 04 522 A1 an inhibitor for wet-chemical etching of structures is described wherein the inhibitor is added to an etching solution. The inhibitor creates a protective skin for protection of the flanks of etching channels. It is described that the inhibitor reduces the reaction to the flanks. However, this method requires specific inhibitors for respective processes which restrains a general application of this method.

In DE 199 08 960 a further method for etching of layers of a flat carrier is described, wherein the thickness of the layer of one side is different from the thickness of the layer of the other opposing side. An individual treatment time for each side of the carrier is set and the treatment time is proportional to the thickness of the layer to be etched. This is carried out by temporary interruption of the processing if a shorter time in comparison with longest possible treatment time is necessary. The period for interruption may be zero in case of maximum layer thickness.

In DE 199 08 960 C2 it is described in paragraph [0021] that during each interruption of an etching process a temporary reetching occurs by adhering etching solution. A period of interruption that is shorter than the period where reetching takes place is not reasonable for this application. In general a thin layer may be etched in a reduced etching time. In case of reetching a periodic interruption is meaningful.

In DE 101 54 886 A1 a method for a reduction of etching at flanks of etching channels is described. The removal of metallic material is performed in two method steps. First, the metallic material is electrolytically removed by applying a pulsed electrical field. This etching happens preferably in depth direction of the etching channel wherein the flanks are attacked to a lower extent. After reaching a certain depth of the etching channels the electrical connections of some structures are disconnected. Therefore, the area on the base of such an etching channel has to be reetched in a further process that requires a further technical effort.

It is an object of the present invention to provide a method and a device which allow a wet-chemical process for a precise treatment of structures on surfaces thereby achieving a short treatment time.

The object is accomplished by providing a method according to claim 1 and a device according to claim 15. Advantageous embodiments are described in the subclaims.

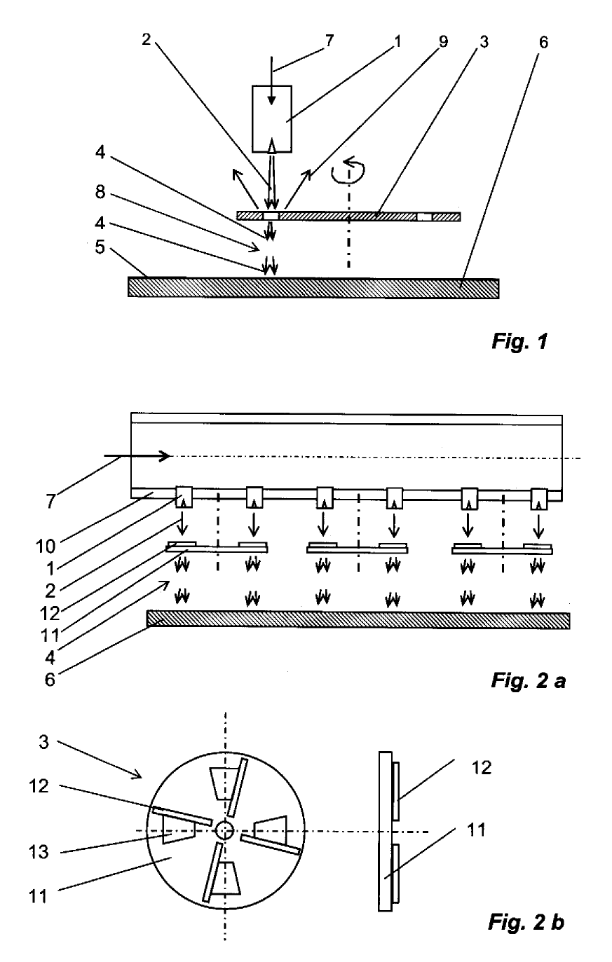

An example of the invention will now be described in detail with reference FIGS. 1 to 5.

FIG. 1 shows schematically the basic principle for forced wet-chemical treatment of surfaces;

FIG. 2a shows a cutaway of a first embodiment with a rotary interrupt means as disk anteriorly of the nozzles;

FIG. 2b shows a detail of the interrupt means of FIG. 2a;

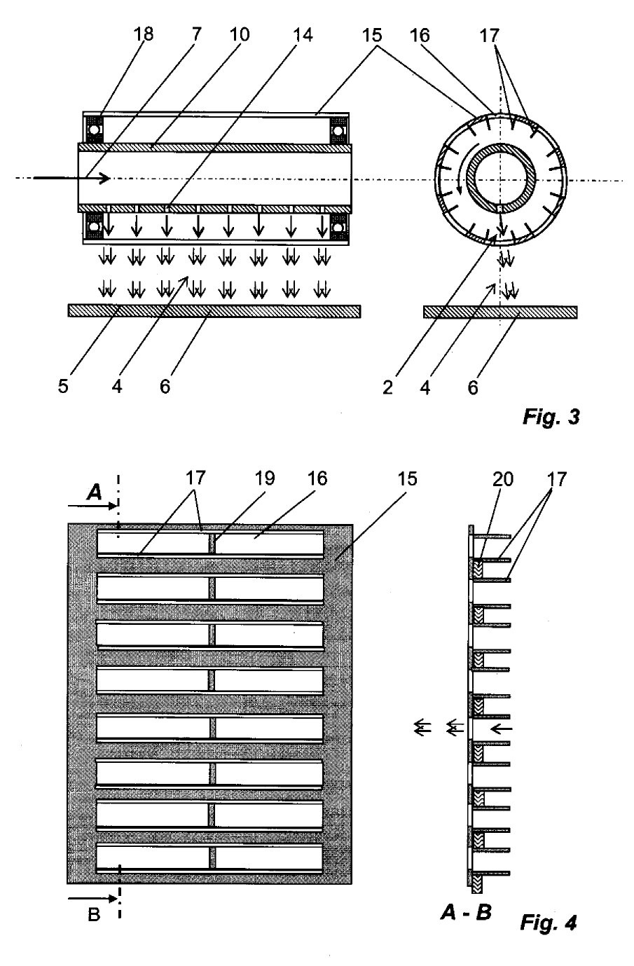

FIG. 3 shows two views of a further exemplary embodiment with a rotating cylinder as interrupt means;

FIG. 4 shows by way of two views the developed view of the rotating cylinder of FIG. 3;

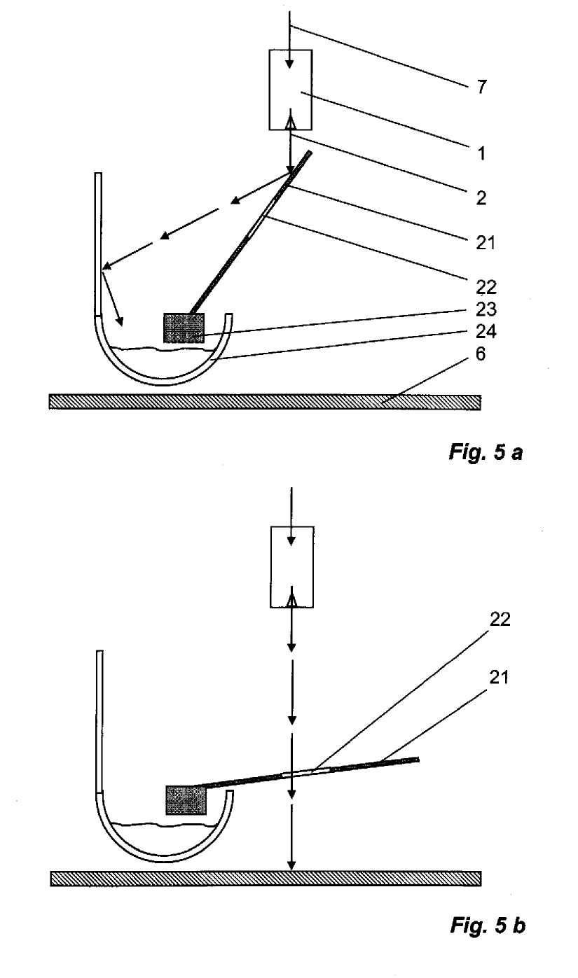

FIG. 5 shows an exemplary embodiment of the invention with a vibrating interrupt means in two positions.

FIG. 1 shows a spray jet 2 of treatment fluid flowing from an opening or nozzle 1 wherein the spray jet 2 is chopped, i.e. interrupted in a repeated manner, by a moving interrupt means 3 which is provided with openings. The cyclically interrupted jet 2 reaches as effective jet 4 the surface 5 of a material 6 to be treated in a hydrodynamically pulsating manner. The spray jet 2 works as an effective jet 4 that is hydrodynamically pulsating. The fluid of the effective jet 4 is called in the following an effective fluid 8. The treatment fluid, which accumulates at the interrupt means 3 during a pulse pause and is not used, should be designated as a reactive fluid 9. This reactive fluid 9 is kept away largely from the surface 5 of the material 6 to be treated. This reduces adhering of treatment fluid on the surface 5 of the material 6. Thus, the dynamic influence of the interrupted and pulsating effective jet 4 is enhanced significantly during chemical treatment. On the surface 5 of the material 6 to be treated this effective jet 4 causes a permanent impact and breaking-through of the surface wetted with treatment fluid is achieved. Such an impact action substantially supports the actual wet-chemical process by reducing the thickness of the diffusion layer. This hydrodynamic support is useful for all processes mentioned above including swill process. The treatment time is reduced up to 50% by means of the impact action. The achieved precision during structure treatment is not influenced in a negative way which is a significant advantage and is very surprising since methods for forcing wet-chemical processes according to prior art have an unfavorable influence to the quality of treatment results.

The cyclic interruption of the treatment jet is performed with a frequency, which is at least 0.5 Hz, preferably 10 Hz to 100 Hz or more. The pulse/pause ratio is 10:1 to 1:10, preferably 2:1 to 1:2. The drive of the interrupt means may be performed electromotive, electromagnetic, pneumatic, hydraulic or by means of other actuator devices. The invention may be combined with other known measures for improvement of wet-chemical treatment results, e.g. with inhibitors in a treatment fluid.

It has been determined that the method according to the invention, e.g. for etching of precision tracks on printed circuit boards, results in a reduction of treatment time of approximately 33% wherein no further undercutting of the resist was discovered in comparison with results achieved by methods according to prior art. In spite of the intensive etching process flanks in the etch channels remained unchanged. It is assumed that the impact effect on the base of the etch channel is much greater compared to the effect on the flanks of the structures. Furthermore, it is suspected that during pulse pauses on the one hand the treatment fluid does not flow to the surface of the material and on the other hand the treatment fluid can drain away from the etch channels. During the following etch pulse the treatment fluid remained in etch channels is free from pressure and the effective jet 4 penetrates the thinner diffusion layer up to a greater depth. Especially in precision conductor technology, so called HDI technology, the necessary depth of cutting of an etch channel achieves the width of the track. This is a big challenge for all processes of the printed circuit board technology. Fluid pressure on the flanks caused by the treatment fluid, as it is known in prior art, is avoided by means of the inventive pulsating treatment of deep structured channels. Consequently, flanks of the structures are less wet-chemically treated compared with the base of the channels. Thus, by applying the inventive method it is possible to enhance significantly the precision of the wet-chemical treatment while significantly reducing the treatment time without loss of quality.

During etch experiments, the distance of the nozzles 1 to the surface 5 of the material 6 amounted to 100 mm. The flow rate of the treatment fluid through each of the taper nozzles having an apex angle of 30° amounted to 1.6 liters per minute at a pressure of 3 bar (300.000 N/m²).

FIG. 2a illustrates a cross section of a tubular spraying device 10 that is equipped with several nozzles 1. Instead of nozzles, it is cheaper to provide the device 10 with holes having an opening diameter of e.g. 0.5 mm to 3 mm. The treatment fluid flows pressurized through the inlet 7 into the spraying device 10 and discharges pressurized the device 10 through the nozzles 1. The pressure can vary largely. The pressure can be 1.1 to 100 bar depending on the process, the dimensions of the structures and the positioning of the nozzles in relation to the lower side or the upper side of the material 6. A rotatable interrupt means as perforated disk 11 having holes or recesses is positioned in front of the nozzles 1. The perforated disk is provided with catches 12 that are exposed to a part of the spray jet 2 of the treatment fluid. Thereby, the perforated disk 11 is set in motion. The disk 11 interrupts the spray jet 2 so that the treatment fluid as effective jet 4 reaches in a pulsed manner the surface 5 of the material 6. In FIG. 2b a perforated disk is illustrated for two pairs of nozzles 1. Each pair of nozzle 1 is arranged at the spraying device 10 wherein each pair of nozzles 1 is differently inclined according to predetermined direction of rotation of perforated disk 11. In the perforated disk 11 there are openings 13 as holes or slots, as is illustrated in FIG. 2b.

The interrupt means may also be arranged as a perforated or slotted strip axially in front of the nozzles or holes extending along the whole length of the spraying device. The strip having openings is moved cyclically and in axial direction in order to interrupt the spray jet 2.

The spraying devices 10 can be stationary located e.g. in a continuous processing plant with horizontal or vertical transport of the material 6 wherein the spraying devices are spaced 100 mm apart in transport direction. However, they can be movably arranged as is known in wet-chemical machines according to prior art. In this respect, the inventive spraying devices 10 in combination with interrupt means 3 may perform radially and/or axially swivelling or oscillating movements. Thereby, an accumulation of fluid on the surface of the material is reduced.

FIG. 3 illustrates a section of a further spraying device 10 with holes 14 or nozzles. A swivelling or rotary cylinder 15 is coaxially located to the spraying device 10 wherein the cylinder 15 is provided with slots 16 or holes arranged on the circumference of the cylinder and being congruent to the holes of the spraying device 10. The slots 16 or holes each are provided with a collar 17 at both sides thereof. Such a collar 17 serves as a contacting surface for the slightly inclined spray jet 2 whereby the cylinder is set in motion. Furthermore, the collars 17 accumulate the treatment fluid that should not reach the surface 5 of the material 6 during a pulse pause. The treatment fluid is laterally discharged from the cylinder. A slight inclination of the spraying device 10 and the cylinder 15 supports the lateral discharge of the treatment fluid. Therefore, this portion of fluid does not reach the surface 5 of the material 6. Thereby, the wetting of the surface to be treated is reduced to a minimum so that the impact effect described above is improved. This device is well suited for wet-chemical treatment of a surface of a material if this material is transported horizontally through a continuous processing plant. Treatment fluid that is not necessary is kept away from the surface of the item to be treated.

Bearings of the cylinder may be arranged at the end of the spraying device. For this, rolling bearings 18 can be used wherein such bearings have to be chemically resistant against a respective treatment fluid. Rolling bearings composed of plastics or ceramics are suitable.

The cylindrical interrupt means and other interrupt means may be set in motion by an electric, pneumatic or hydrodynamic drive. Thereby, the rotational speed is independent from the physical properties of the spray jet 2. Especially, high rotational speeds and a high pulse cycle may be adjusted, e.g. 1000 pulses per second. Thereby, the effective jet is transformed in a short cycle of highly accelerated drops of treatment fluid in case of high pressure in the inlet 7. This is particularly effective for the wet-chemical process. Due to the rough atmosphere, air-cooled motors or appropriately protected electric motors are applicable.

Electric and electronic control devices of the wet-chemical plant adjust process parameters depending on required treatment of the material. The same is with the adjustment of the interrupt frequency and the ratio between pulse time and pulse pause of the effective jet 4.

FIG. 4 shows the developed view of the cylinder 15 in two views. Webs 19 may be arranged between nozzle positions in order to stabilize the cylinder 15 provided with slots 16 so that spray jet 2 is not hindered. On the base of an area of the cylinder 15 where the treatment fluid is accumulated an elastic item as damper 20 may be inserted. This damper 20 reduces an uncontrolled splashing of the treatment fluid when the fluid hits onto the inside wall of the cylinder 15. In addition, this accelerates the lateral discharge of the treatment fluid from the cylinder 15.

In FIG. 5a and FIG. 5b a nozzle 1 and an interrupt means 3 as vibrating lamina 21 is illustrated. This elastic machine element is mounted in a fixed point 23. The interrupt means is arranged in front of the nozzle 1 such that the spray jet 2 hits the upper end of the lamina 21 whereby the spray jet 2 is diverted. Thereby, the lamina 21 is bent in direction to the spray jet 2 so that an outlet 22 in the lamina 21 is positioned in the jet direction, see FIG. 5b. The outlet 22 opens the path to the surface of the material 6 to be treated. The effective jet of the treatment fluid abruptly reaches the material 6. Simultaneously, the dynamic pressure on the lamina 21 is reduced. Thereby, the lamina 21 returns abruptly into its starting position as illustrated in FIG. 5a. In this position, the spray jet 2 of the treatment fluid is diverted as reactive jet and is collected by a collection channel 24. The treatment fluid, which should not reach the surface of the material, is diverted laterally and transversally to the spraying device by the collection channel 24. The collection channel 24 extends parallel to the surface 5. This embodiment of the present invention is suitable for a treatment at both sides of a material horizontally transported. The elastic properties and dimensions of the lamina and the hydrodynamic conditions of the treatment fluid determine the optimum pulse frequency of the wet-chemical treatment.

The interrupt means according to this embodiment is also suited for an accommodation in the nozzle itself in case of respective small dimensions. Using nozzles provided with such an interrupt means or with a similar interrupt means, the discharge of treatment fluid during a pulse pause is prevented. Therewith, these nozzles are furthermore suited to be placed on upper side of a horizontally transported material.

According to a further embodiment of the invention, an additional suction device is provided for an exhaust of treatment fluid reflecting from the surface 5 of the material 6. Therewith, a fluid accumulation on the surface 5 of the material 6 is prevented and unnecessary residue of fluid is avoided so that undercutting of conductor tracks is further reduced.

### LIST OF REFERENCE SIGNS

1 nozzle, opening

2 spray jet of the treatment fluid

3 interrupt means

4 effective jet, pulsating jet

5 surface to be treated

6 item

7 inlet

8 effective fluid

9 reactive fluid

10 spraying device

11 perforated disk

12 catch

13 opening

14 hole

15 cylinder

16 slot

17 collar

18 rolling bearing

19 bridge

20 damper

21 lamina

22 outlet

23 fixed point

24 collection channel

1.-28. (canceled)

29. A method for a wet-chemical treatment of a surface of a material, comprising the steps of:
supplying a treatment fluid from an immersion plant or continuous processing plant to a nozzle;
ejecting the treatment fluid by the nozzle in the form of a spray jet in a direction towards a material to be treated; and
displacing the spray jet by a spray jet interrupt member positioned downstream of the nozzle such that the spray jet hits on the interrupt member and impinges discontinuously on a surface of the material.

30. The method of claim 29, for wet-chemical treatment of a surface of a printed circuit board, wafer or hybrid material.

31. The method of claim 29, wherein the displacing step includes the step of moving the interrupt member to undergo a rotational, swivelling or linear movement.

32. The method of claim 29, wherein the discontinuous impingement of the spray jet on the material is performed cyclically at an interrupt frequency of at least 0.5 Hz.

33. The method of claim 29, wherein the discontinuous impingement of the spray jet on the material is performed cyclically at an interrupt frequency of 10 Hz to 100 Hz.

34. The method of claim 29, wherein the discontinuous impingement of the spray jet on the material occurs with a ratio of impingement pulse time to impingement pulse pause that a range from 10:1 to 1:10.

35. The method of claim 29, wherein the discontinuous impingement of the spray jet on the material occurs with a ratio of impingement pulse time to impingement pulse pause that a range from 2:1 to 1:2.

36. The method of claim 29, wherein the interrupt member collects treatment fluid and keeps the fluid away from the surface of the material.

37. The method of claim 36, wherein the treatment fluid is kept away from the surface of the material by a collar or a collection channel or a suction device.

38. A device for wet-chemical treatment of a surface of a material, comprising:
a nozzle receiving a treatment fluid from an immersion plant or continuous processing plant to direct a spray jet towards a material to be treated;
at least one spray jet interrupt member arranged downstream of the nozzle and constructed displaceably to discontinuously guide the spray jet in a direction toward the material.

39. The device of claim 38, wherein the material is a printed circuit board, a wafer or a hybrid material.

40. The device of claim 38, wherein the interrupt member is constructed for executing a rotary, swivelling or linear movement.

41. The device of claim 38, wherein the interrupt member interact with the nozzle in such a way that the spray jet of the treatment fluid is ejected by the nozzle at an overpressure to apply a force on the interrupt member by which the interrupt member is displaced.

42. The device of claim 38, wherein the interrupt member is arranged between the nozzle and the material and is constructed in the form of a cylinder which rotates or swings about the nozzle.

43. The device of claim 38, wherein the interrupt member is constructed in the form of a vibrating or oscillating element.

44. The device of claim 38, wherein the interrupt member comprises a collection channel which extends in parallel relationship to the surface of the material and collects an unnecessary portion of the spray jet.

45. The device of claim 38, further comprising a suction device for removing excess treatment fluid from the surface of the material.
